(19) United States
(12) Patent Application Publication
(10) Pub. No.: US 2002/0111792 A1
(43) Pub. Date: Aug. 15, 2002

(54) Document storage, retrieval and search systems and methods

(76) Inventor: Julius Cherny, Monsey, NY (US)

Correspondence Address: FISH & NEAVE, 1251 AVENUE OF THE AMERICAS, 50TH FLOOR, NEW YORK, NY, 10020-1105, US

(21) Appl. No.: 10/039,727

(22) Filed: Jan. 2, 2002

Related U.S. Application Data
(60) Provisional application No. 60/259,562, filed on Jan. 2, 2001.

(51) Int. Cl. G06F 17/20

(52) U.S. Cl. 704/8

(57) ABSTRACT

Systems and methods for monolingual or multilingual search, storage, or retrieval of documents are provided. Searching, storing or retrieving of documents may require the documents to be organized according to the topic which may pervade the documents. The text of documents may be coded to identify parts of speech, clause types, grammatical functions, or meanings of words. Documents may be translated before being stored or retrieved, and search results may be translated before being presented.

### CROSS REFERENCE TO RELATED APPLICATION

This application claims the benefit of U.S. Provisional Application No. 60/259,562 filed Jan. 2, 2001, which is hereby incorporated by reference herein in its entirety.

### BACKGROUND OF THE INVENTION

The present invention relates to systems and methods for document storage, search, or retrieval. More particularly, the present invention relates to systems and methods for storing, retrieving or searching for documents monolingually or multilingually.

Translation between languages is well known, and is frequently performed manually by individuals that are fluent in both the source and target languages. Human translators may have the ability to translate written or spoken text, often with a very high degree of accuracy.

Human translation is frequently accurate because the translator is often knowledgeable about the topic or subject matter that the communication is based on. However, costs associated with translation services are typically high. A translator must be familiar with both the source and target languages, as well as with the specialized subject matter to be translated. For example, if two physicists who speak different languages needed to communicate, the translator would need to be knowledgeable about physics, in addition to being fluent in both languages, so that many “terms of art” would be translated with their proper meaning.

Currently, documents relating to a variety of different topics may be created, stored, searched and retrieved electronically. However, such documents often are written in different natural languages. Natural languages may suffer from lexical and structural ambiguities. Lexical ambiguity may result from the polysemy of words, where words may have multiple meanings. Structural ambiguity may result when a group of words may be interpreted in a plurality of ways.

Difficulties exist in electronically searching, storing and retrieving documents that have been created in different natural languages. For example, a user of an electronic document storage, retrieval, and search system may only be familiar with one language, but may wish to view the content of documents written in other natural languages. Such a user is typically unwilling to incur the expense of translating documents that may or may not be relevant.

Typical translation costs can be avoided by using electronic translation, but such translation is commonly difficult because of the lexical and structural ambiguities that exist in natural languages, as well as with terms of art that exist in the text.

Accordingly, it is is an object of the present invention to provide systems and methods for monolingual or multilingual document search, storage, or retrieval where accurate translation may be performed.

### SUMMARY OF THE INVENTION

In accordance the above and other objects of the present invention, systems and methods for monolingual or multilingual search, storage, or retrieval of documents are provided.

Searching, storing and retrieving documents may be provided by organizing documents according to one or more topics which may pervade the documents. Documents may be lexically and structurally disambiguated. Codes may be attached to text of the documents to identify parts of speech, phrase or clause types, or grammatical functions. A multilingual semantic object database may be created to store coded text objects, and a synthetic/natural pairs database may be created to store parallel images of strings of words in two or more languages. Creation of parallel images of text may allow for translation of text from one language to another.

In some embodiments, a monolingual or multilingual search for a document may be performed. The system may receive a query for a document from a user. The system may also receive user selections of class areas or specific categories which may limit the scope of the query. The query may be lexically and structurally disambiguated. The disambiguated query may be converted into semantically equivalent queries, where a database of semantically coded objects may be used to perform the conversion. The semantically equivalent queries may be broadcast to web servers or servers with databases. The results of the search may be reviewed for duplicates, which may be eliminated. If results are not in the language of the query, they may be translated. The results may be presented to a user, and the user may have the option of focusing the query to produce a broader or narrower search.

A user may perform monolingual and multilingual storage of documents in some embodiments. The system may receive a document created by a user. Lexical and structural disambiguation may be performed by the system on the language of the document. The document may be coded, and semantic objects may be created to identify parts of speech, clause types, and grammatical functions. If the document is in English, it may be stored. If the document is not in English, the document may be translated into English by pairing English semantic object data with non-English semantic object data. In some embodiments, an iterative process of adding, removing, or substituting words to refine the translation may be necessary. Once the document has been translated, it may be stored.

In some embodiments, a user may perform monolingual and multilingual retrieval of documents. The system may receive a query for a document from a user. The system may also be adapted to receive user selections of class areas or specific categories which may limit the scope of the retrieval query. The query may be lexically and structurally disambiguated. The disambiguated retrieval query may be converted into semantically equivalent queries, where a database of semantically coded objects may be used to perform the conversion. The semantically equivalent queries may be broadcast to web servers or servers with databases. The results of the search may be reviewed for duplicates, which may be eliminated. If documents found are not in the language of the query, they may be translated and presented to the user.

### BRIEF DESCRIPTION OF THE DRAWINGS

Further features of the invention, its nature and various advantages will be more apparent from the following detailed description of the preferred embodiments, taken in conjunction with the accompanying drawings, in which like reference characters refer to like parts throughout, and in which:

FIG. 1 is an illustrative implementation of a document storage, retrieval, and search system constructed in accordance with principles of various embodiments of the present invention;

FIGS. 2A-2G are flow diagrams illustrating various aspects of monolingual and multilingual document storage techniques in accordance with principles of various embodiments of the present invention; and

FIGS. 3A-3E are flow diagrams illustrating various aspects of monolingual and multilingual document search and retrieval in accordance with principles of various embodiments of the present invention.

### DETAILED DESCRIPTION OF THE DRAWINGS

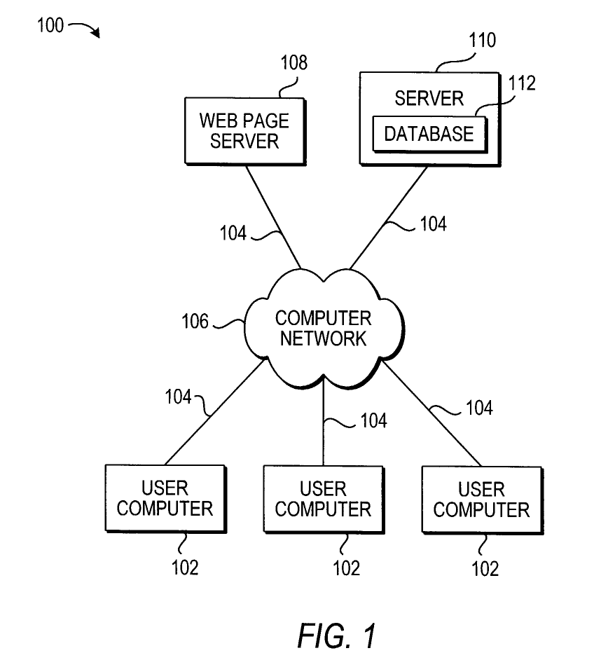

The present invention is now described in more detail in conjunction with FIGS. 1-3.

FIG. 1 is an illustration of a hardware implementation of a document storage, retrieval, and search system in accordance with various embodiments of the present invention. As shown, system 100 may include one or more user computers 102 that may be connected by one or more communications links 104, through one or more computer networks 106 to web page server 108, as well as to server 110 with database 112.

User computer 102 may be a computing device, processor, personal computer, laptop computer, handheld computer, personal digital assistant, computer terminal, a combination of such devices, or any other suitable data processing device. User computer 102 may have any suitable device capable of receiving user input, such as a keypad, writing tablet, voice-activated input speaker or the like.

Communications links 104 may be optical links, wired links, wireless links, coaxial cable links, telephone line links, satellite links, lightwave links, microwave links, electromagnetic radiation links, or any other suitable communications link for communicating data between user computers 102 and servers 108 and 110.

Computer networks 106 may be the Internet, an intranet, a local area network (LAN), a wide area network (WAN), a metropolitan area network (MAN), a virtual private network (VPN), a wireless network, an optical network, a cable network, a digital subscriber line network (DSL), or any other suitable network, or any combination of such networks.

Web page server 108 may be a processor, a computer, a data processing device, or any other suitable server that may provide web page content or services to computer networks 106 or user computer 102 over communications links 104.

Server 110 may be a processor, a computer, a data processing device, or any other suitable server that may provide information or services to computer network 106 or user computer 102 over communications links 104. Server 110 may contain or be coupled to database 112, which may provide information that may be searched, retrieved or manipulated.

All interactions between user computers 102, web page server 108, and server 110 may preferably occur via computer networks 106 and communication links 104. Users of user computers 102 may conduct monolingual or multilingual document storage, retrieval or searching using suitable input devices that are connected to, or are integral with, user computers 102.

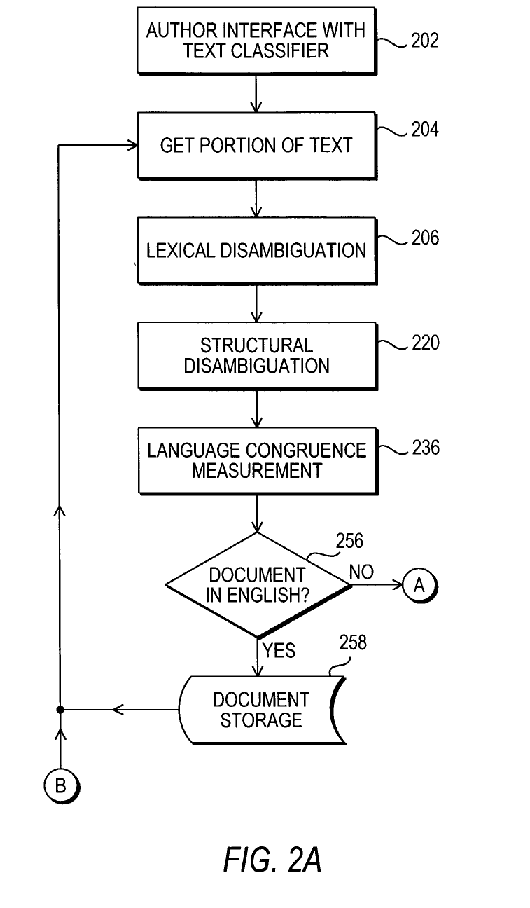

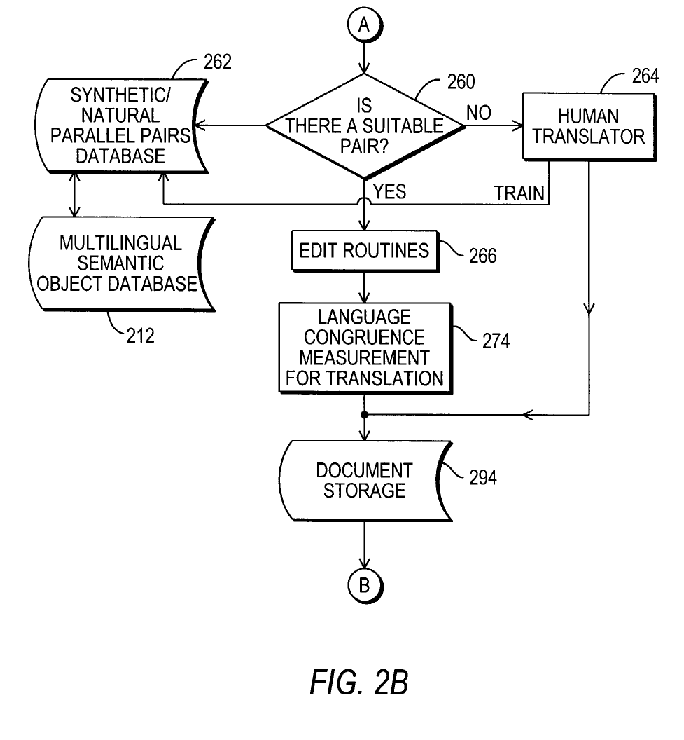

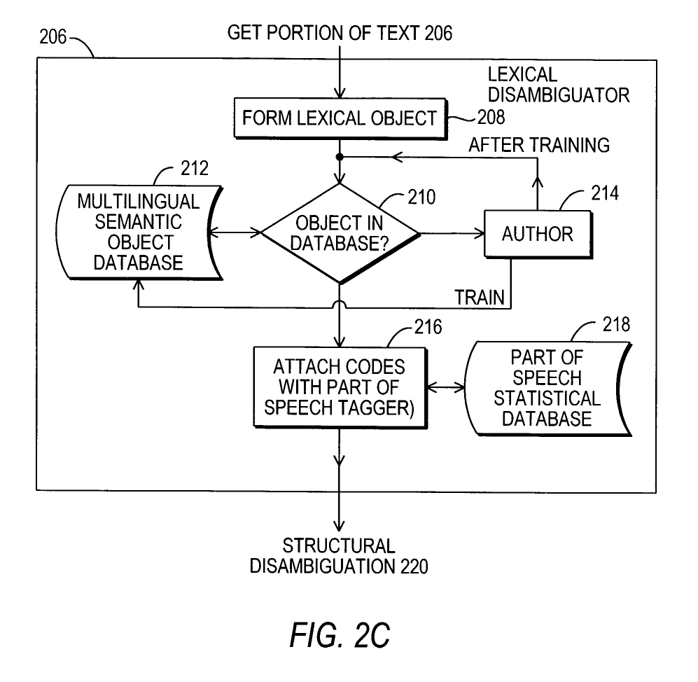

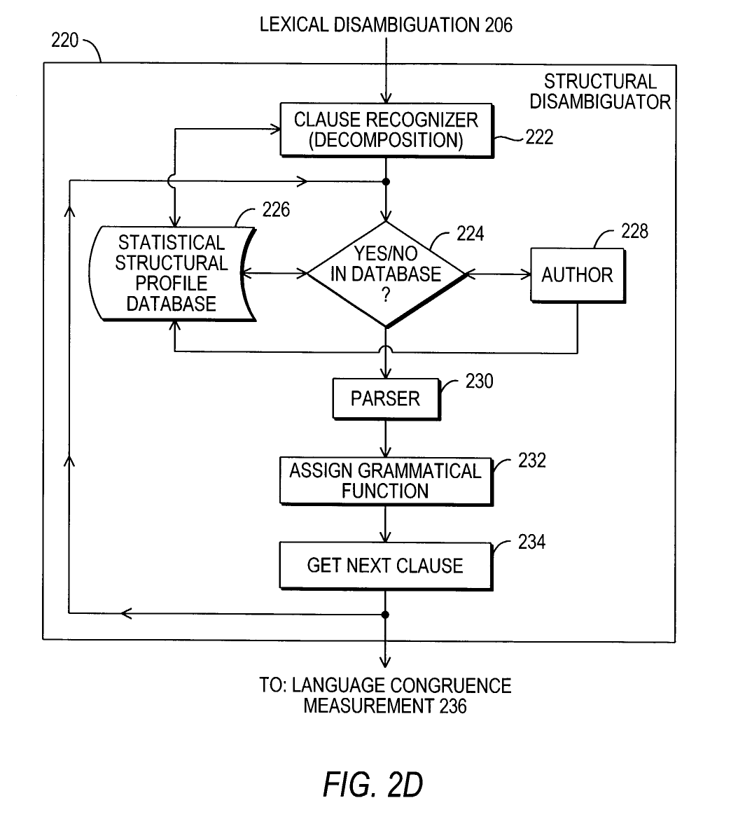

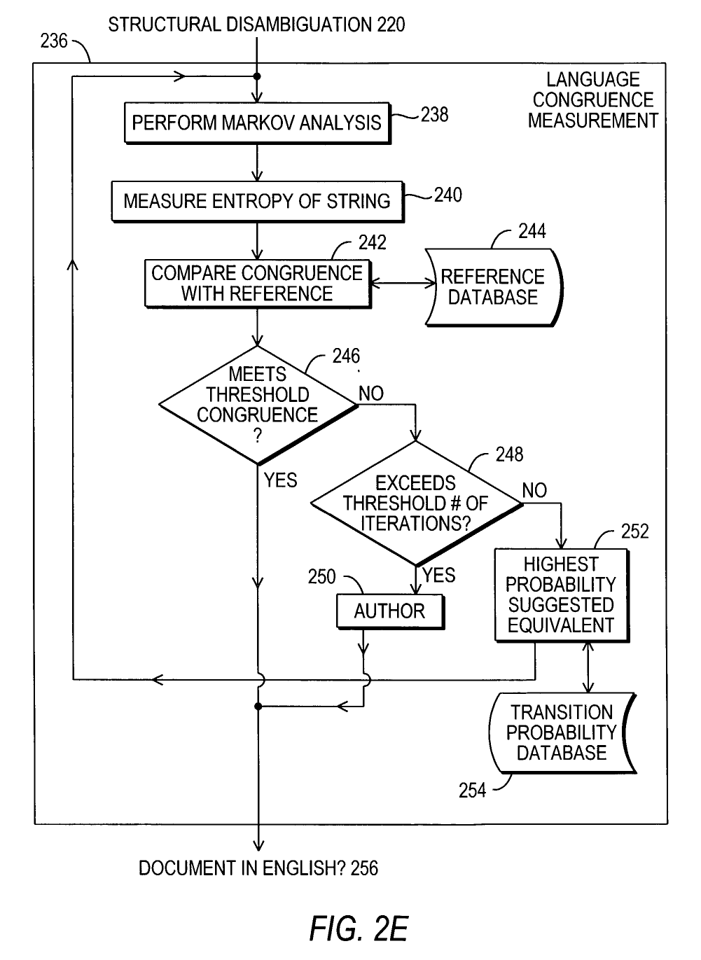

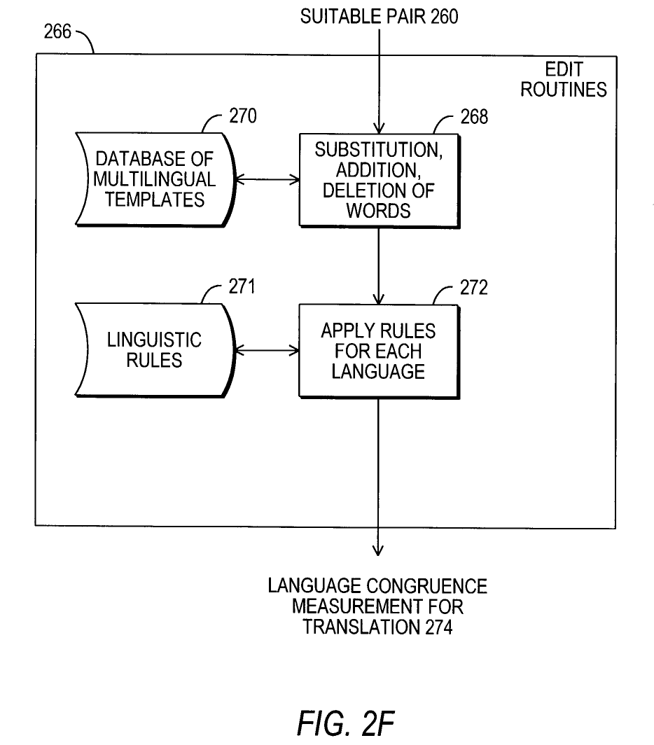

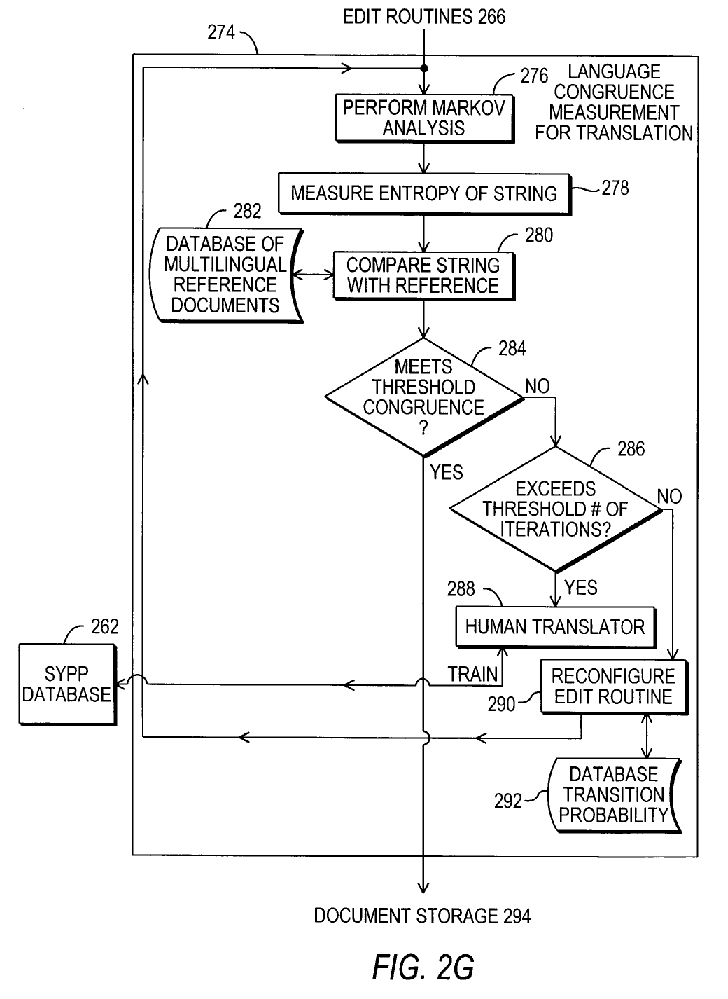

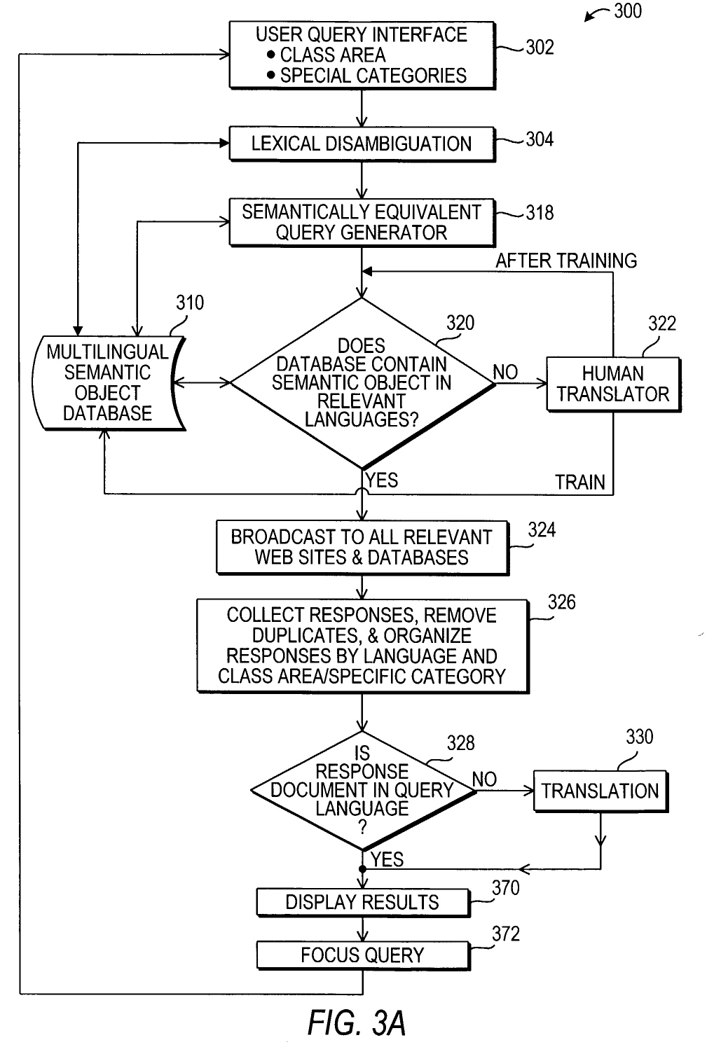

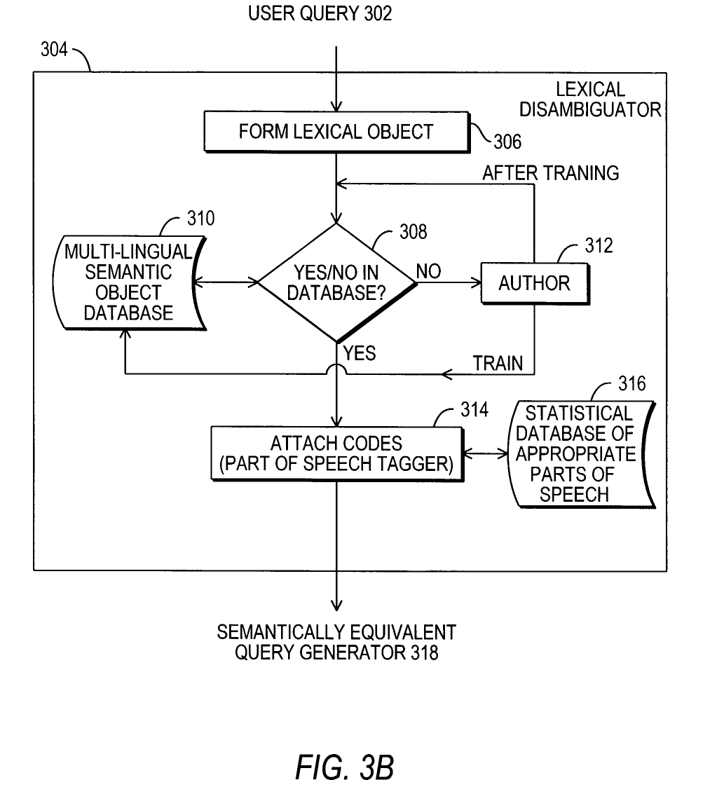

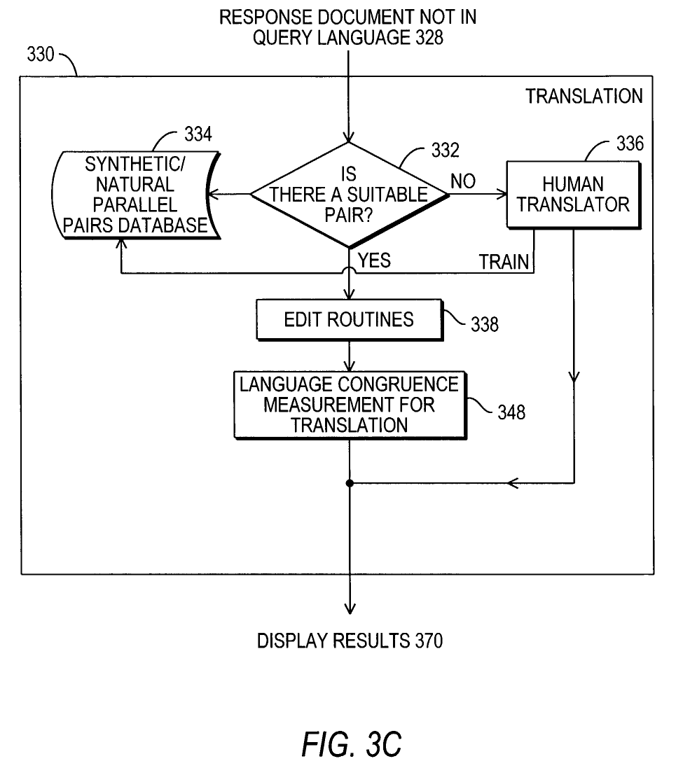

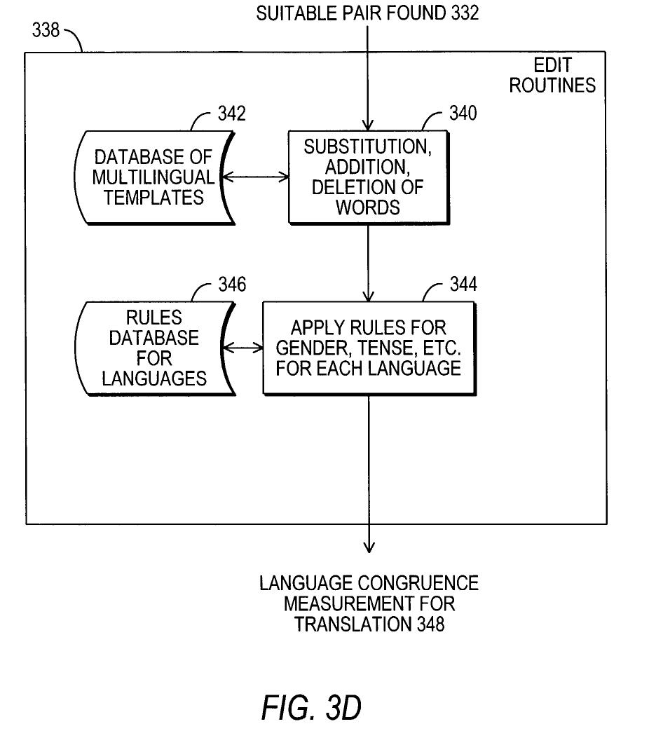

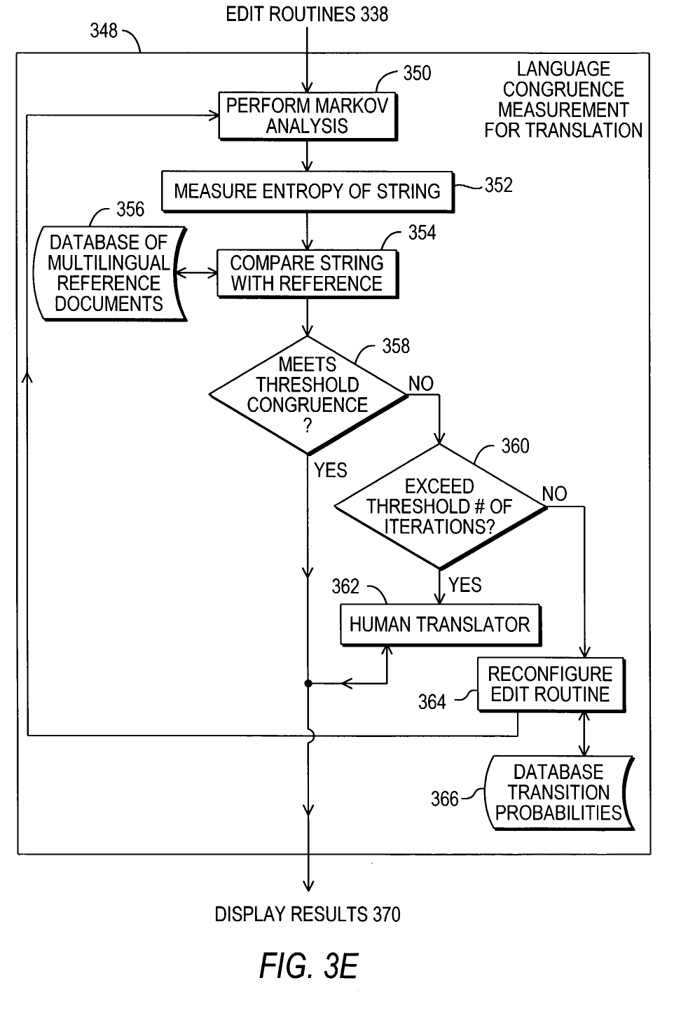

FIGS. 2A-2G are flow diagrams illustrating monolingual and multilingual document storage in accordance with various embodiments of the present invention. As shown, document storage process 200 may include step 202, where a user interface may allow a user to enter or refine monolingual or multilingual documents for storage. Step 202 may also allow a user to select class areas or specific categories in which the document being created may be stored. A hierarchy may be established, with class areas being comprised of different categories. For example, “science” may be established as a class area, with “physics,” “chemistry” or “biology” established as specific categories of the class area. Either the class area or the catagories may be used as a topic that a user may search on, as is described more fully below in connection with FIGS. 3A-3E.

At step 204, the document to be stored may be parsed into smaller portions of text. For example, the document may be parsed by word, phrase, clause, sentence, paragraph, page, or any other suitable grouping of text. Parsing the text of the document to be stored may be necessary in order to facilitate tagging of the text for searching or retrieving documents in the future, as well as for document translation purposes.

Process 206 may lexically disambiguate the parsed text of the document to be stored. Natural languages may contain words with multiple meanings (polysemus). The meaning of words may be derived from the subject matter or context in which the word appears, as well as from the words adjacent to the polysemus word. Lexical disambiguation process 206 may clarify the meaning of a particular word or phrase. Such clarification may be necessary before assigning codes to the word or phrase. In some embodiments, the such codes may be useful for document searching, retrieval, or translation.

As shown in FIG. 2C, process 206 may include the following steps and elements: form lexical object step 208, object in database test step 210, multilingual semantic object (MSO) database 212, author step 214, attach codes step 216, and statistical part of speech database 218.

Step 208 may form lexical objects from the portion of text parsed at step 204. A lexical object may be a word or group of words that may convey meaning. Once the lexical objects have been formed, test 210 may determine whether the lexical objects are in multilingual semantic object database 212.

MSO database 212 may include lexical objects which, for example, may be used by test 210. Initial creation of MSO database 212 may be achieved by coding the text of various documents available in the public domain. MSO database 212 may grow by adding multilingual semantic objects, creating additional class areas and specific categories, and by expanding the number of natural languages in the database. The coding schemes may facilitate multilingual document search, storage, and retrieval.

The coding schemes may include semantic, synonymic, hierarchic, specific category, or any other suitable coding scheme. Using a semantic coding scheme, words may be classified according to meaning. Words may also be coded by synonymy, where the code may group words together that may represent the same concept.

Hierarchic coding may be divided into hyponymy and meronymy. Hyponymy may refer to the relation of inclusion. For example, lion is a hyponym of animal, since the meaning of lion includes the meaning of animal. Meronymy may refer to a part/whole relationship. For example, a cover and pages are meronyms of a book. Lexical objects may be independently be coded for hyponymy and meronymy.

The specific category code may be similar to the specific category coding that may be specified by the user and attached to the whole document at step 202. However, specific category coding at test 210 using MSO database 212 may code individual lexical objects.

If test 210 determines that the lexical objects are in MSO database 212, the semantic, synonymic, hierarchic, and specific category codes may be retrieved from MSO database 212 and applied to the lexical objects.

If it is determined at step 210 that the lexical object is not contained in MSO database 212, author step 214 may allow a user to manually code semantic, synonymic, hierarchic, and specific category codes for the lexical object inputs into MSO database 212 or to heuristically train the MSO database. Once the database has been modified, the lexical objects may be found in the MSO database and coded at step 210 (see the “After Training” link from step 214).

Next, at step 216, a Part of Speech Tagger (PST) may assign functional parts of speech tags to lexical objects using database 218. Parts of speech, such as nouns and verbs, may be identified and tagged. Database 218 may be used by step 216 to determine the appropriate part of speech tag to be appended to the lexical object using statistical methods or pattern matching algorithms. Again, such tagging may facilitate the translation of documents.

After lexical disambiguation process 206, the text may be structurally disambiguated with process 220. Structural disambiguation may break down text into clauses or phrases, and appropriately tag grammatical functions or clause types. Tagging may be necessary in order to facilitate accurate translation of documents. As shown in FIG. 2D, process 220 may include clause recognizer step 222, in database test 224, statistical structural profile database 226, author step 228, parser step 230, assign grammatical function step 232, and get next clause step 234.

Clause recognition step 222 may decompose the parsed text from step 202 into different types of clauses. Types of clauses may include independent, subordinate, nominal, relative, or any other suitable type of clause.

Test 224 may determine if the clauses are in statistical structural profile database 226. If a clause is not in the database, author interface step 228 may be used to enter clause structural profile information into database 226 or heuristically train database 226 to apply appropriate codes to clauses. If the clause is in the database, statistical methods or pattern matching algorithms may be used to decompose portions of text into clauses, categorize the clauses according to type, and tag them. Database 226, which may be used by clause recognizer step 222 and test 224, may contain statistics on the structural profiles of clauses such that the clauses of the parsed text may be appropriately tagged. Clause identification and classification may be necessary for language translation as a part of document search, storage, or retrieval.

After the text has been decomposed into clauses, step 230 may break down the clauses into phrases. The phrases may be noun phrases, verb phrases, or any other suitable phrases. Next, at step 232, a grammatical function may be assigned to the phrase. Grammatical functions may include subject, predicate, direct object, or any other suitable grammatical function. The categorization of phrases and grammatical functions may be adapted for language translation as a part of document search, storage, and retrieval.

Step 234 may retrieve the next clause from the portion of text. The newly retrieved text may then be decomposed, categorized and tagged by process 220.

Referring back to FIG. 2A, language congruence measurement process 236 may occur after structural disambiguation process 220. A more detailed flow diagram of the steps of language congruence measurement process 236 is illustrated in FIG. 2E. As shown, process 236 may include performing Markov analysis step 238, measuring entropy step 240, comparing congruence with reference document step 242, reference document database 244, threshold congruence probability test 246, exceed threshold number of iterations test 248, author step 250, highest probability suggested equivalent step 252, and transition probability database 254.

At step 238, a Markov statistical analysis or any other suitable analysis may be performed on the text coded during the previous steps of process 200. Markov statistical analysis may examine the sequencing of random variables. The controlling factor in Markov statistical analysis may be a transition probability, which is a conditional probability for the system to go to a particular new state, given the current state of the system. A phrase, clause, sentence or other suitable grouping of words may be viewed as a sequence of words. Markov analysis may be used to determine the transition probabilities between words in a particular word sequence.

Next, at step 240, using the results of the Markov analysis for transition probabilities between words, the entropy of the string of words may be determined. Entropy may be the collective probability of the sequence of words. Probabilities of a sequence of words may be weighted based on length of the sequence, since sentences or other portions of text (e.g., phrases or clauses) may be of varying lengths.

Step 242 may compare the transition probability or the entropy measurements for a word sequence with the transition probabilities or entropy for a word sequence in a reference document. This may determine the congruence or consistency between the word sequences of the parsed text and the reference.

Reference database 244 may contain reference documents which may be compared to the word sequence. An appropriate reference document may be selected on the basis of the class area or specific categories as selected by the user at step 202. In some embodiments, an appropriate reference document may be selected from the class area and specific categories of the lexical objects contained in the word sequence.

Step 246 may determine whether the comparison between the word sequence and the reference text meets a threshold congruence level. The threshold congruence level may be defined by a user. If the congruence level does meet threshold, the next step may be to determine if the text of the document to be stored is in English at step 256 (see FIG. 2A).

If the congruence level does not meet threshold, the number of iterations in a revision process may be checked to determine if a threshold level of iterations is exceeded. A user may establish the threshold number of iterations. If the threshold number of iterations has not been exceeded, step 252 may determine the highest probability suggested equivalent using transition probability database 254.

If the threshold number of iterations is exceeded, step 250 may use an interface to allow a user to edit the portion of text in order to achieve a suitable congruence before proceeding to step 256 of FIG. 2A.

Step 252 may harmonize the language of the document to be stored with respect to a reference document. The congruence may be improved by the substitution, addition, or deletion of semantic objects.

Transition probability database 254 may contain Markov transition probabilities for a variety of word sequences. Database 254 may be used in manipulating the parsed text fragment such that the transition probability of the string of words may be improved. Words may be substituted in the text to be stored in order to create a more suitable Markov transition probability in a new sequence with the additional word or words than with the original word sequence. Similarly, words may be added or removed from the original sequence in order to improve the Markov transition probability.

Congruence threshold test 246 may be performed on the new string after the modification of the original sequence of text, Markov analysis step 238, entropy measurement step 240, and comparing congruence with reference step 242. This iterative process of string manipulation may be performed until the word string meets the predefined threshold level of congruence. Alternatively, the threshold level of iterations may be exceeded and an interface may be used to directly manipulate the string to improve the congruence.

In some embodiments, an iterative heuristic process generally known as a “hill climbing strategy” may be used to modify the original text string such that it may meet the threshold level of congruence at step 246. The hill climbing strategy is a variant of a “generateand-test” algorithm. The generate-and-test algorithm involves:

(1) generating a possible solution;

(2) determining if the proposed solution is an actual solution by comparing a state with an acceptable goal state; and

(3) quitting if a solution is found, but otherwise repeating steps 1-3.

The hill climbing strategy may use feedback from the test procedure to determine which direction to move in a search space. The test function may return an estimate of how close a given state is to a goal state. The goal state of the hill climbing strategy may achieve threshold congruence between the text to be stored and a reference text.

The hill climbing strategy may use feedback from congruence test 246 to add, delete, or substitute words of the text to be stored in order to improve congruence. A solution may be found when the congruence level meets threshold. However, if the number of iterations exceeds a threshold level, step 250 may allow a user to manually edit the text to achieve congruence.

There are several variations of the hill climbing strategy. A simple hill climbing algorithm may involve:

(1) evaluating an initial state. If it is a goal state, return the state and quit. Otherwise, the algorithm may continue with the initial state as the current state;

(2) loop until a solution is found or until there are no new operators left to be applied in the current state;

(a) select an operator that has not yet been applied to the current state to produce a new state;

(b) evaluate the new state:

(i) if it is a goal state, return it and quit;

(ii) if it is not a goal state but it is better than the current state, then make it the current state; and

(iii) if it is not better than the current state, continue the loop.

The steepest-ascent hill climbing algorithm is a variation on the simple hill climbing algorithm. This algorithm may involve:

(1) evaluating the initial state. If it is a goal state, return it and quit. Otherwise, continue with the initial state as the current state;

(2) Looping until a solution is found or until a complete iteration produces no change to the current state;

(a) let “success” be a state such that any possible successor of the current state will be better than “success”;

(b) for each operator that applies the current state do:

(i) apply the operator and generate a new state;

(ii) evaluate the new state. If it is a goal state, return it and quit. Otherwise, compare it to “success.” If it is better, then equate “success” to this state.

If it is not better, leave “success” alone;

(c) If the success is better than the current state, then set the current state to “success.”

In the steepest-ascent hill climbing algorithm, “success” may be when the text to be stored exceeds a threshold level of congruence with a reference text.

Basic hill climbing or steepest-ascent hill climbing may fail to find a solution. Either algorithm may terminate by finding a goal state (exceeding a threshold level of congruence) or by reaching a state from which no better states may be generated. This may occur if a local maximum, a “plateau,” or a “ridge” is reached.

A local maximum may be a state which is better than its neighboring states on a hierarchical tree of states, but is not better than other states farther away. A plateau may be a flat area of search space where a set of neighboring states may have the same value. A ridge may be an area of the search space that is higher than surrounding areas on a hierarchical tree of states. However, if the number of iterations with the algorithm exceeds a threshold level, a user may manipulate the text at step 250 to achieve congruence.

Referring once again to FIG. 2A, after language congruence measurement process 236, test 256 may determine whether the text of the document to be stored is in English. If the text is already in English, the document text may be stored at step 258. After storing the text, a new portion of text to be stored may be retrieved at step 204.

If the document to be stored is not in English, the text of the document may still be parsed at step 204, lexical disambiguation may be performed at step 206, structural disambiguation may be performed at step 220, and a language congruence measurement may be performed at step 236. These steps may add to the multilingual semantic object database 212, statistical structural profile database 226, and other suitable databases.

In order to translate the document into English, step 260 (see FIG. 2B) may determine whether there is a suitable semantic pairing between the source language of the document text and the target language, which is English. Suitable pair test 260 may utilize synthetic/natural parallel pairs database 262.

Synthetic/natural parallel pairs (SYPP) generator function 262 may be used by test 260 and may produce aligned parallel pairs of words strings. “Parallel” may indicate that two strings of words may be images of one another in two or more languages. “Aligned” may indicate two images that are coupled such that if one image is called upon, the other image should appear as well. “Natural pairs” may be the aligned parallel pairs that are extracted from previously translated text. “Synthetic pairs” may be pairs developed from texts that are in essentially the same subject. “Word strings” may be words, phrases, clauses, sentences, or any suitable grouping of words.

Word strings may have content words, such as nouns or verbs, but may also have other words such as modifiers, functions, or any other suitable words. SYPP generator function 262 may select appropriate semantic objects from MSO database 212 that may represent the words of the word string.

Semantic object codes for content words or other words may be used to form a vector of semantic objects. The elements of the vector may be weighted. Content words may be weighted in unity, while modifiers and function words may be weighted by a compound value. The compound value may be the result of at least two measures. One measure may be based on the frequency of association between an individual content word and the other words (i.e., modifiers and functions). The other measure may be based on the distance between the associated word and the content word. The computation of the compounded measure may be the frequency divided by the distance.

Weighted vectors may be brought together into a n×n similarity matrix. The entries in the matrix may be values which represent the distance that the values of a given weighted vector are from a chosen fixed reference weighted vector. These distances may act as a measure of similarity amongst the weighted vectors.

SYPP generator function 262 may utilize the “stable marriage algorithm” to form a suitable target language image of the source language vector by using semantic objects in MSO database 212. The stable marriage algorithm may be applied by SYPP generator function 262 to find the most similar set of coded words in the n×n similarity matrix to form a vector word string. The set of code words may be ordered in a vector, where the beginning of the ordering may start with the content words, thereby anchoring the word string around the content words. Modifier and function words may be added, based on the weighting information of the similarity matrix. In some embodiments, the balance of the ordering may also utilize Markov transition probabilities, which may be obtained from a database or from previous steps in process 200. The construction of the source and target language vector word strings may be executed so as to achieve the highest possible congruence.

The stable marriage algorithm may include the steps of:

(1) determining which set of members will be “proposed to” by the members of the other set and line them up. Thus, there may be a “proposed to” set and a “proposing” set;

(2) matching each member of the proposing set with the first choice from the proposed to set, given that some choices will be the same;

(3) each member of the proposed to set may keep the best choice of those present and sends the rest away;

(4) if the resulting pairing is one of mutual first choices or of best choices from each member's remaining preferences, the pairing may be deemed “stable” and the pair is removed;

(5) each member of the proposing set who has been sent away goes to the next best choice;

(6) repeat steps 3-5 until all members of both sets have been paired.

Thus, the stable marriage algorithm may be used to pair semantic objects from the source language (the language of the document to be stored) and the target language. One set of objects from one language may be “proposed to,” and the set of objects from the other language may be “proposing.”

If no suitable pair of semantic objects exists between the source and the target language, step 264 may use a human translator to train MSO database 212, as well as to translate the text into English for storage at step 290. After storage, a new portion of text for storage may be acquired at step 204 of FIG. 2A.

If SYPP generator 262 has produced a pairing, the elements of the pairing may not be acceptable translations of each other. In some embodiments, SYPP generator 262 may substitute semantic object for semantic object. However, additional semantic objects may be needed in order to produce an accurate translation from a source language to a target language. Also, the source and target languages may have different rules (e.g., rules regarding gender, tense, etc.) that may need to be resolved in order to achieve an accurate translation. If a suitable pairing of semantic objects between the source and target languages may be made, edit routines process 266 may refine the translation.

As shown in FIG. 2F, edit routines process 266 may utilize database of multilingual templates 270. The multilingual templates may be used to ascertain whether words may need to be substituted, added, or deleted at step 268 in order to prepare text for accurate translation. In addition, language-specific rules may be applied at step 272 for the source or target languages in order to yield an accurate translation. Step 272 may rely upon database 271 that contains linguistic rules for a variety of languages.

Language congruence measurement for translation process 274 may be the next stage in translating the text of the document from the source language to the target language. As shown, FIG. 2G illustrates language congruence measurement process 274. Process 274 may include performing Markov analysis 276, measuring entropy 278, comparing string with reference step 280, multilingual reference documents database 282, threshold congruence test 284, threshold iterations test 286, translation step 288, edit routine reconfiguration 290, and transition probability database 292.

Step 276 may be used to perform a Markov analysis on the elements of the pairing. Markov analysis may be used to determine the transition probabilities between the words in a particular sequence.

Next, at step 278, using the results of the Markov analysis for transition probabilities between words, the entropy of the string of words may be determined. Entropy may be the collective probability of the sequence of words. Probabilities of a set of words may be weighted based on length, since sentences may be of varying lengths.

Step 280 may compare the transition probability and the entropy measurements for a word sequence with the transition probabilities and entropy for a word sequence in a reference document to determine the congruence or consistency between the word sequences. Reference database 282 may contain reference documents which may be compared to the word sequence. An appropriate reference document may be chosen on the basis of the class area and specific categories as selected by the user at step 202, or from the class area and specific categories of the lexical objects contained in the word sequence.

Step 284 may determine whether the results of the Markov analysis of step 276 and entropy measurement step 278 meet a predefined threshold congruence level. The threshold congruence level may be defined by a user. If the predefined congruence measurement is met, the translated document may be stored at step 294 (of FIG. 2B) and a new portion of the document to be translated and stored may be retrieved at step 204 (of FIG. 2A).

If the threshold congruence is not met, it may be determined if a threshold number of iterations has been exceeded at step 286. If the number of iterations has been exceeded, a translator may be used at step 288 to train SYPP database 262 (see FIG. 2B) and translate the document for storage at step 294. If the threshold number of iterations has not been exceeded, edit routine reconfiguration process 290 may be invoked.

Process 290 may be used to improve the congruence and the pairing of semantic objects. This may improve the translation between the source and the target languages. Process 290 may harmonize the language of the document to be stored in relation to a reference document. The congruence may be improved by the substitution, addition, or deletion of semantic objects.

Transition probability database 292 may contain Markov transition probabilities for a variety of word sequences. This probability information may be used in manipulating the parsed text such that the transition probability of the string of words may be improved.

Words may be substituted in the text to be stored. This may create a more suitable Markov transition probability in a new sequence of words. Similarly, words may be added or removed from the original sequence in order to improve the Markov transition probability.

Upon the modification of the original sequence of text, Markov analysis step 276, entropy measurement step 278, comparing congruence with reference step 280, and a congruence threshold test 284 may be performed on the new word string. This iterative process of string manipulation may be performed until the word string meets the predefined threshold level of congruence, or the threshold level of iterations is exceeded and an interface may be used to directly manipulate the string. Once the text has been edited, steps 276, 278, 280 and 284 may be performed again until the threshold congruence is reached or the threshold number of iterations has been exceeded.

FIGS. 3A-3E are flow diagrams illustrating monolingual and multilingual document search and retrieval in accordance with various aspects of the present invention. Step 302 may allow a user to enter queries in order to search and retrieve documents. Also, in a similar fashion to step 202 of FIG. 2A, step 302 may allow a user to select class areas or specific categories (i.e., a topic) in which the document being searched for or retrieved may belong.

As shown in FIG. 3B, process 304 may lexically disambiguate the query entered by the user at step 302. Similarly to process 206 shown in FIG. 2C, process 304 may include form lexical object step 306, object in database test 308, multilingual semantic object database 310, author step 312, attach codes step 314, and statistical part of speech database 316.

Step 306 may form lexical objects from the user query. Again, lexical objects may be any word or group of words that convey meaning. Once the lexical objects have been formed, step 308 may determine whether the lexical objects are in MSO database 310. The semantic objects in the database may be organized by codes, where the coding schemes may include semantic, synonymic, heirarchic, specific category, or any other suitable coding scheme. In addition to codes, the semantic objects may also be organized by class area or specific categories.

If it is determined at step 308 that the lexical objects are not contained in the MSO database 310, author step 312 may allow a user to manually code the lexical object into MSO database 310. Once the MSO database has been manually coded, the lexical object may be found at step 308, and codes may be attached to the object.

If the lexical objects are in the MSO database, a Part of Speech Tagger (PST) may assign functional parts of speech tags to lexical objects at step 314. Parts of speech, such as nouns or verbs, may be assigned at step 314 using statistical part of speech database 316. Database 316 may be used to statistically determine the appropriate part of speech tag to be appended to the lexical object.

Next, semantically equivalent queries may be generated at step 318 of FIG. 3A. The semantically equivalent queries may be generated by substituting synonyms or combinations of synonyms of the semantic objects of the query. Because a user-entered query may be a word, word string, or phrase, it may not be necessary to determine the congruence between the original query and the semantically equivalent queries. In some embodiments, semantic object substitution may be sufficient, since the results of the search may eventually be refined.

Step 320 may be to determine whether MSO database 310 contains semantic objects in the relevant search languages. The user may have previously selected the languages of documents in which to perform a search. Semantic objects for the original query or the semantically equivalent queries may have been generated. Step 320 may determine whether equivalent objects are available in MSO database 310 for the query objects.

If equivalent multilingual objects are not available in MSO database 310, a human translator may be used at step 322 to train MSO database 310 heuristically or code objects directly into database 310. After training, test 320 may recognize that the appropriate multilingual objects may exist in the database, and the multilingual semantic objects of the query may be broadcast at step 324. If the equivalent multilingual objects are available in MSO database 310, multilingual queries may be formed and broadcast at step 324.

Step 324 may broadcast the queries in each of the requested languages. These queries may be broadcast on the Internet, an intranet, a local area network (LAN), a wide area network (WAN), a metropolitan area network (MAN), a virtual private network (VPN), a wireless network, an optical network, an asynchronous transfer mode network (ATM), a cable network, a frame relay network, a digital subscriber line network (DSL), or any other suitable network or combination of networks. Queries may also be broadcast to computing devices or servers that may be connected to a computer network that may containing relevant databases or web pages.

Step 326 may collect the results from the broadcasted queries. Duplicate documents or listings may be removed, and responses may be organized by language, as well as by class area or specific category.

Next, at test 328, the responses in the query language may be separated from the rest of the responses. If the responses are in the query language, step 370 may display the results and step 372 may allow a user to focus the query. If the responses are not in the query language, process 330 may translate the responses into the query language.

FIG. 3C illustrates translation process 330, which may convert a non-query language response into the language of the query. A pairing of semantic objects may be made between the query language and the non-query language. Test 332 may determine whether a suitable pairing may be made between the semantic objects of the query language and semantic objects of the non-query language. In order to render this determination, the synthetic/natural pairs database (SYPP) function 334 may be used. If a suitable pair may not be found, human translation may be used at step 336 to train SYPP database 334. A suitable pair of semantic objects may then be formed at step 322 after training.

If a suitable pairing of semantic objects is obtained for each language, edit routines process 338 may be performed for each relevant language as illustrated in FIG. 3D. Substitution, addition, or deletion of semantic objects that may be selected based on multilingual templates database 342. The multilingual templates may be used to determine whether words may need to be substituted, added, or deleted in order to prepare text for accurate translation. In addition, language-specific rules may be applied at step 344 using database 346 for both the source and target languages in order to yield a translation.

Language congruence measurement for translation process 348 illustrated in FIG. 3E may be the next stage in translating the text of the document from the source language to the target language (English). Process 348 may include performing Markov analysis 350, measuring entropy 352, compare string with reference step 354, database of multilingual reference documents 356, threshold congruence test 358, threshold iterations test 360, translation step 362, edit routine reconfiguration 364, and transition probability databases 366.

Step 350 may be used to perform a Markov analysis or any other suitable analysis on the elements of the pairing. Markov analysis may be used to determine the transition probabilities between the words in a particular sequence.

Next, at step 352, using the results of the Markov analysis for transition probabilities between words, the entropy of the string of words may be determined. Entropy may be the collective probability of the sequence of words. Probabilities of a set of words may be weighted based on length, since word strings may be of varying lengths.

Step 354 may compare the Markov transition probabilities and the entropy of the string of words with a suitable reference document. Suitable reference documents may be contained in database 356. A reference document may be chosen based on language, class area, specific category, or other suitable criteria.

Step 358 may determine whether a predefined threshold congruence level is met with the comparison of the word string with the reference text. The threshold congruence level may be defined by a user. If the predefined congruence measurement is met for translation, the results of the search may be displayed at step 370 and the search may be refined at step 372.

If the threshold congruence is not met, it may determine whether a threshold number of iterations has been exceeded at step 360. The threshold number of iterations may be configured by the user. If the number of iterations has been exceeded, a translator may be used at step 362 to translate the result for display at step 370. If the threshold number of iterations has not been exceeded, edit routine reconfiguration process 364 may be invoked.

Process 364 may utilize multilingual templates database 366 and multilingual rules database 368 to add, subtract or substitute words to improve the congruence of words to be translated. After editing the text to be translated, analysis steps 350, 352 and 354 may be performed again.

Turning back to FIG. 3A, the results of the search query may be displayed at step 370. A user may select from amongst the choices listed in order to retrieve a desired document. If the document is not written in the language of the query, it may be translated with a method similar to translation process 328 illustrated in FIG. 3C.

The user may refine the scope of their query at step 372. The user may user the query interface of step 302 to select class areas or specific categories (i.e., topic), or add terms to the search.

Thus, it is seen that systems and methods for monolingual or multilingual document storage, retrieval, or search have been provided. It will be understood that the foregoing is merely illustrative of the principles of the invention and the various modifications can be made by those skilled in the art without departing from the scope and spirit of the invention, which is limited only by the claims that follow.

What is claimed is:

1. A method of monolingual and multilingual document storage comprising:
receiving a document created by a user;
retrieving a portion of text from the received document;
determining the meaning of the words in the portion of text;
comparing the portion of the text with a reference document;
determining whether the text is in English; and
storing the document based at least in part on the determinations of the portion of the text.

2. The method of claim 1, further comprising:
classifying the document to be stored by a topical category;
coding the document with a category code.

3. The method of claim 1, further comprising:
forming at least one lexical object from the retrieved text, wherein a lexical object is a word or series of words which convey meaning; and
attaching codes to the lexical object, wherein the codes identify parts of speech.

4. The method of claim 3, further comprising:
determining whether a lexical object is located in a database of objects; and
retrieving the lexical object.

5. The method of claim 4, further comprising manually coding the lexical object into the database if the object is not located in the database.

6. The method of claim 1, further comprising:
parsing the portion of text into clauses; and
attaching codes to the formed clauses to identify grammatical clauses.

7. The method of claim 6, further comprising:
parsing the clauses into phrases; and
assigning grammatical functions to the phrases.

8. The method of claim 1, further comprising:
determining the transition probability of words in the portion of text;
determining the entropy of words in the portion of text; and
comparing the determined transition probability and entropy with a reference transition probability and entropy value.

9. The method of claim 8, further comprising adding, removing or substituting words of the portion of the text to increase the similarity between the transition probability and entropy values with that of the reference text.

10. The method of claim 8, further comprising determining whether a threshold number of iterations to manipulate the text to achieve similarity between the text and the reference document.

11. The method of claim 10, further comprising manipulating the portion of text to achieve threshold similarity between the text and the reference.

12. The method of claim 1, further comprising translating the text in English.

13. The method of claim 12, further comprising:
matching semantic objects of source and target languages to facilitate translation; and
determining whether additional words need to be added to achieve an accurate translation.

14. A method of monolingual and multilingual document searching and retrieving comprising:
receiving a search query created by a user;
determining the meaning of the words in the query;
creating semantically equivalent queries;
broadcasting the equivalent queries to at least one server;
receiving at least one response to the broadcast;
determining whether the results are in the query language; and
displaying the results.

15. The method of claim 14, further comprising:
classifying the topic of the search; and
coding the query with a category code.

16. The method of claim 14, further comprising:
forming at least one lexical object from the query, wherein a lexical object is a word or series of words which convey meaning; and
attaching codes to the lexical object, wherein the codes identify parts of speech.

17. The method of claim 16, further comprising:
determining whether a lexical object is located in a database of objects; and
retrieving the lexical object.

18. The method of claim 17, further comprising manually coding the lexical object into the database if the object is not located in the database.

19. The method of claim 14, further comprising selecting languages to search for documents in.

20. The method of claim 19, further comprising determining whether lexical objects for the selected languages are in a database.

21. The method of claim 20, further comprising manually coding the database of lexical objects for the objects in the selected languages.

22. The method of claim 14, further comprising translating the results into the language of the query.

23. The method of claim 22, further comprising:
matching semantic objects of source and target languages to facilitate translation; and
determining whether additional words need to be added to achieve an accurate translation.

24. The method of claim 23, further comprising adding, removing or substituting words of the portion of the text to increase the similarity between the transition probability and entropy values with that of the reference text.

25. The method of claim 23, further comprising:
determining the transition probability of words in the portion of text;
determining the entropy of words in the portion of text; and
comparing the determined transition probability and entropy with a reference transition probability and entropy value.

26. The method of claim 23, further comprising:
determining whether a threshold number of iterations to manipulate the text to achieve similarity between the text and the reference document; and
prompting a user to manipulate the portion of text to achieve threshold similarity between the text and the reference.

27. A system for monolingual and multilingual search, storage, or retrieval of documents comprising:
at least one user computing device;
at least one remote server, wherein the remote server may contain databases or web pages;
at least one computer network; and
a communications link connecting the user computing device, remote server and computer network, wherein the communications like allows the transfer of data.

28. The system of claim 27, wherein the computer network is the Internet.
